(19) United States
(12) Patent Application Publication
(10) Pub. No.: US 2006/0288880 A1
(43) Pub. Date: Dec. 28, 2006

(54) Gentle dry bin filler

(76) Inventor: Malcolm E. Hanks, Yakima, WA (US)

Correspondence Address: STRATTON BALLEW, 213 S 12TH AVE, YAKIMA, WA, 98902, US

(21) Appl. No.: 11/477,898

(22) Filed: Jun. 28, 2006

Related U.S. Application Data
(60) Provisional application No. 60/695,737, filed on Jun. 28, 2005.

(51) Int. Cl. A23G 1/10

(52) U.S. Cl. 99/485

(57) ABSTRACT

A bin filler apparatus for gently and automatically filling a storage bin with a fruit, such as apples. The bin filler includes an organizer with an infeed conveyor for delivering the fruit to an organizing mechanism, for positioning the fruit into a succession of fruit rows for transfer to a delivery head. The delivery head includes a pair of opposing wave belt type of conveyor belts, spaced apart to receive and contain the succession of fruit rows without compressing or squeezing the fruit. The wave belts collapse a they travel around the rollers of the conveyor belt and the second roller, releasing each fruit row, in succession, into the storage bin.

### BACKGROUND OF THE INVENTION

The cost of harvesting tree fruit in the United States is a major barrier to producing quality fruit at globally competitive prices. It was reported that in the year 2000, the United States produced 12,632 million pounds of apples and pears and paid and estimated 200 million dollars to have it picked. One study has shown that harvesting labor amounts to 29.1% of the total variable costs of production of tree fruit. For this reason a method of reducing the cost of harvesting fruit is a significant opportunity for the tree fruit industry. A key barrier to reducing the cost of production of high quality fruit is the lack of an effective method of automatically filling the storage bin with apples in the orchard that will not cause significant damage to the fruit.

If an apple is to be moved successfully in any mechanical handling process, the amount of kinetic energy that the apple is allowed to gain in the process must be carefully controlled. This is because an impact that dissipates a relatively small amount of this energy can damage the apple, rendering it unacceptable for the fresh market.

Bin fillers utilizing water have traditionally been used in packing facilities with some varieties of apples that have a higher bruise threshold, like Red Delicious apples, with some success. The varieties that are more sensitive have always posed a problem for the wet bin filler. Water sanitation and large volumes of waste water to clean or dispose of are also major detriments to this method of bin filling. The benefit of water as a transport medium is that apples float in water, so gravity will not accelerate the apple as it is moved into the bin. Water also has adequate viscosity to absorb most of the kinetic energy that the apple may gain as it is transported to the bin filler.

Many new varieties of apples are gaining a share of the fresh apple market. The industry is discovering that water bin fillers are causing excessive damage to several of these varieties and some packing facilities have moved away from the use of water bin fillers altogether, to “dry” bin filling methods. Furthermore, the use of a wet bin filler is not a practical consideration in an orchard setting because of size and sanitation.

U.S. Pat. No. 4,194,343 to Myers et al. describes a dry bin filling device that incorporates a set of opposing brush belts to deliver fruit into a bin. The brushes spaced apart along the length of the belts, perpendicular to the direction of movement. The brushes pivot to allow for varying sizes of fruit, and gently engage the fruit between the conveyors.

U.S. Pat. No. 6,442,920 to Peterson et al. discloses a combination harvester and bin filler. A wave-type belt is utilized to convey fruit to a bin. The wave-type of belt exhibits promise to reduce damage to fruit, especially in the transfer from one belt to another. However, no provision is made for organized arrangement of the fruit, nor the filling of the entire bin, side to side and front to back.

A dry bin filler compatible with a harvesting aid to automatically fill a storage bin with fruit in the orchard would be useful in the commercial fruit industry. Other commercial opportunities for a dry bin filler include the packing warehouse, where a need exists to refill storage bins with fruit for processors or for a pre-sizing operation.

### BRIEF DESCRIPTION OF DRAWINGS

FIG. 1 is a perspective view of a bin filler, according to an embodiment of the invention;

FIG. 2 is a top view of a bin filler, according to an embodiment of the invention;

FIG. 3 is a side view of a bin filler, according to an embodiment of the invention;

FIG. 4 is a front view of a bin filler, according to an embodiment of the invention;

FIG. 5A is side view of a portion of a bin filler, according to an embodiment of the invention;

FIG. 5B is side view of a portion of a bin filler, according to an embodiment of the invention; and

FIG. 6 is side view of a portion of a bin filler, according to an embodiment of the invention.

### DESCRIPTION OF THE INVENTION

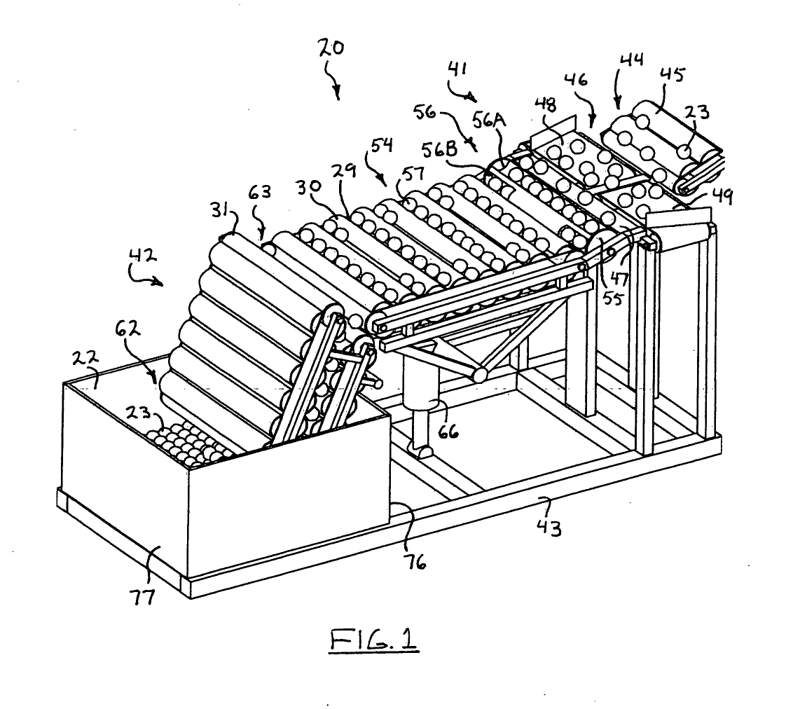

The invention comprises a method and apparatus for filling a bin with fruit that can gently handle the most delicate fruit without damage, and without the need for floatation with water. The dry bin filler described and shown in FIGS. 1 though 6 enhances the efficiency of fruit production, especially apples. Furthermore, the bin filler 20 of the present invention serves as a key element in the drive to implement precision farming technology and information technologies. This bin filling device can be incorporated into the harvesting aid systems, currently being tested in commercial orchards.

The bin filler 20 of the present invention comprises an apparatus and method of filling a typical “bin” or storage bin 22 with a fruit 23. The processed fruit is preferably apples, but may be any generally spherical, harvested commodity. In an alternative, the fruit may be: pears, melons, lettuce heads, oranges, kiwi fruits, squash, peaches or plums, for example. The bin filler is especially useful when coupled with a mechanical harvester, and is uniquely suited for use in the field, orchard or grove, or in a warehouse, packing shed or processing facility. The dry bin filler is able to gently transport fruit to the storage bin, utilizing a wave shaped belt conveyor 25 or “wave belt,” having double layers. Double layer type wave belts are desirable for use in moving fruits and vegetables. Because of the unique geometry of the wave belt, it is possible to transport fruit and deposit it gently upon a padded surface which is subsequently pulled from underneath the fruit.

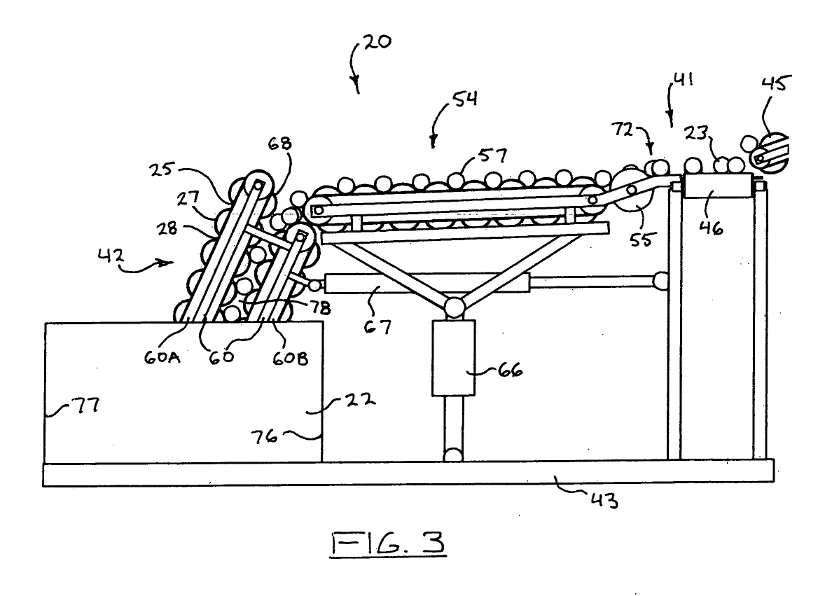

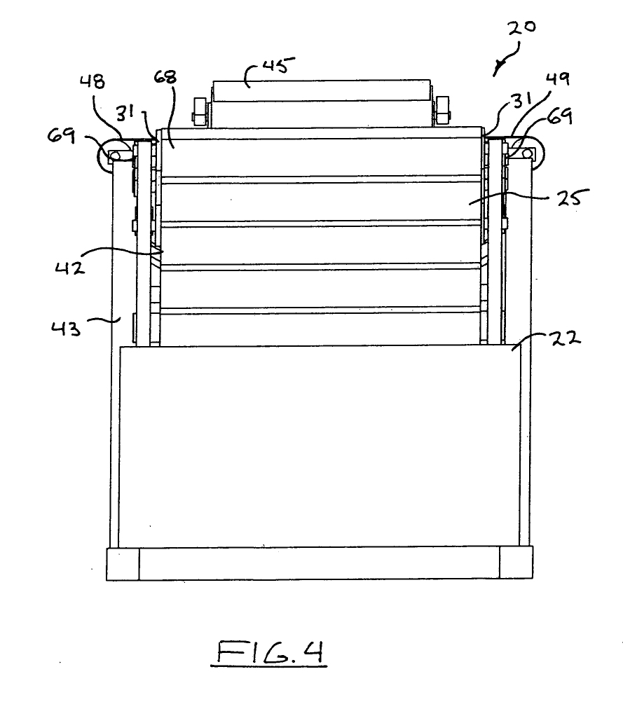

The wave shaped belt conveyor includes an overlying wave belt 27 mounted to an underlying conveyor belt 28. The overlying wave belt is attached to the overlying wave belt at a wave trough 29, regularly spaced along the wave shaped belt. Between each wave trough, the overlying wave belt and the underlying conveyor belt separate, forming a wave ridge 30. The wave shaped belt conveyor operates conventionally as an endless conveyer and includes a first roller 31 and a second roller 32 at each end, around which the underlying conveyor belt travels. As the underlying conveyor belt travels around the first roller or the second roller, the overlying wave belt meets the underlying conveyor belt and the wave ridge momentarily collapses, disappearing as shown in FIGS. 3, 5A, 5B and 6.

The unique geometry of the wave shaped belt conveyor 25 is such that the overlying wave belt 27 collapses against the underlying conveyor belt 28 or “lower belt,” when traveling around both the first lower 31 or “tail roller,” and the second roller 32 or “drive roller.” This creates a highly desirable transport and transfer technique. FIG. 3 illustrates the transfer situation for the wave shaped belt conveyor, in which a row of fruit 33 is transferred from one wave shaped belt conveyor to another. The momentum of each piece of the fruit 23, such as an apple, as it leaves the overlying wave belt is minimized, which is ideal for a fruit transfer system.

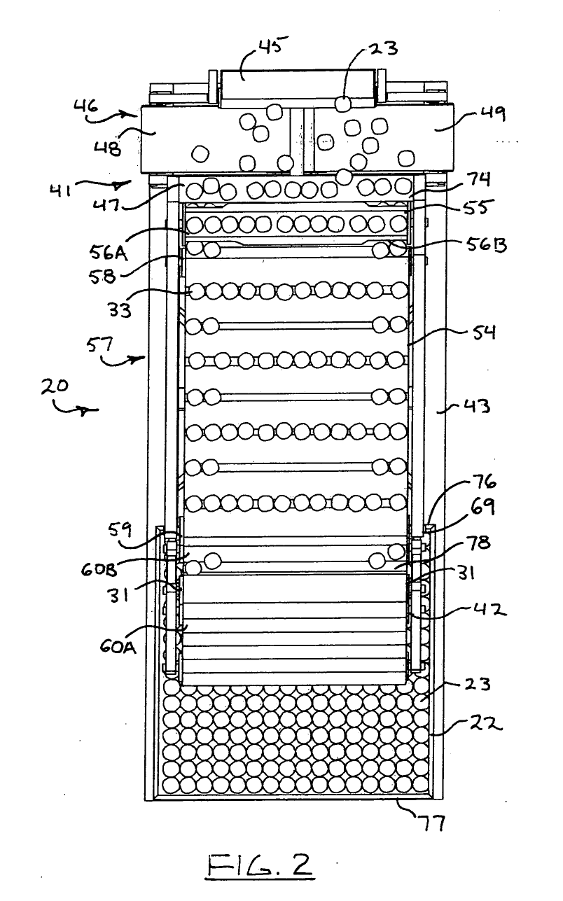

Primary components of the bin filler 20 include an organizer 41 and a delivery head 42, all mounted to filler frame 43, as shown in FIGS. 1 and 3. An infeed 44 supplies the fruit 23 to the organizer. The infeed may be any mechanism for transferring the fruit, such as a chute, conveyor or elevator. Preferably, the infeed includes an infeed conveyor 45 that delivers the fruit to the organizer. Most preferably, the organizer includes an accumulating alternating belt 46. The accumulating alternating belt preferabiy operates to direct the fruit away from the infeed, in a direction that is substantially perpendicular to the direction the fruit is supplied by the infeed. In a most preferred embodiment, the accumulating alternating belt includes a first outward conveyor 48 and a second outward conveyor 49, as detailed in FIG. 2. The purpose of the accumulating alternating belt is to evenly distribute the fruit along the width of the organizer, for orderly introduction into an organizing mechanism 52.

As shown in FIG. 1, the organizer 41 further includes a row feed conveyor 54, which is a belted conveyor that receives the fruit 23 from the organizing mechanism 52. In the most preferred embodiment of the bin filler 20, the row feed conveyor is the same wave shaped belt 25 of the type used with the delivery head 42. The wave shaped belt aids the organizing mechanism, to organize the fruit into rows for transfer to the delivery head. A most preferred organizing mechanism is a row reel 55, as shown in FIGS. 1, 2, and 3. The row reel extends the width of the row feed conveyor and includes a multiple of reel troughs 56.

As shown in FIG. 1, in a preferred embodiment of the organizing mechanism 52 employing the row reel 55 for handling and organizing the fruit 23, the multiple of reel troughs 56, can include a full length reel trough 56A, alternating with an end reel trough 56B. Each of the multiple of reel troughs receives one row of fruit 33. The row reel rotates to deliver the fruit 23 to the row feed conveyor 54 in a succession of fruit rows 57. As the alternating rows of the full length reel trough and the end reel trough are transferred along the row feed conveyor to the delivery head and deposited in the storage bin 22, the accumulation of rows results in an even, regular arrangement of the fruit in the storage bin.

The organizer 41 also include an organizer plate 47 for gathering the fruit onto the row reel 55. The row reel of the organizer receives the fruit rows 33 from the organizer plate, and the row reel rotates when a full row of fruit is detected on the organizer plate. Preferably, the organizer plate is supported by a sensitive spring that signals the row reel to rotate, when sufficient weight of fruit 23 is present on the organizer plate. In an alternative preferred embodiment, the organizer plate can include a plurality of spring supported plates, to ensure the fruit is evenly distributed across the organizer plate.

The row feed conveyor includes a row feed receiving end 58 and a row feed discharge end 59. The row feed receiving end is located proximate to the organizing mechanism 52, as preferably embodied in the row reel 55. The fruit 23 is placed into the row feeding receiving end row by row. After transfer along the length of the row feed conveyor, each fruit row 33 is discharged from the row feed discharge end and into the delivery head 42.

The configuration of the fruit 23 in the row feed conveyor 54 is such that each of the succession of fruit rows 57 includes a full row of fruit in the full length reel trough 56A, wherein the entire width of the row contains fruit, is alternated with a partial row of fruit in the end reel trough 56B, wherein only one piece, or very few pieces of fruit are provided, preferably at each end of the row, and the center of the row contains no fruit.

On the row feed conveyor 54, the “row” for receiving the row of fruit 33, is most preferably formed with the wave trough 29 of the wave shaped belt conveyor 25. Again, as with the delivery head, the wave shaped belt conveyor is a conventional component adapted for use with the present invention, and preferably includes the underlying conveyor belt 28 with the overlying wave belt 27.

After the organizer 41 completes the task of presenting the fruit 23 in the succession of fruit rows 57, the bin filler 20 of the present invention further includes the delivery head 42, for delivering rows of the organized fruit in the efficient transfer from the rotating organizing mechanism to the storage bin 22, as shown in FIG. 3. In a preferred embodiment, the delivery head comprises a pair of opposing wave belts 60, oriented parallel to each other and spaced apart at a slot height 61 sufficient to contain each fruit row 33, without compressing or squeezing the fruit. Each successive row of fruit fed from the row feed conveyor 54 into the delivery head cradles between the opposing wave belts.

The delivery head 42 includes a delivery discharge end 62, proximate to the storage bin 22, and a delivery infeed end 63, proximate to the row feed conveyor 54. The delivery head receives the fruit 23, as each fruit row 33 is discharged from the row feed discharge end 59 of the row feed conveyor. After the fruit descends through the delivery head, each succession of fruit rows 57 is gently placed into the storage bin.

The pair of opposing wave belts 60 includes an upper discharge wave belt 60A parallel to a lower discharge wave belt 60B, as shown in FIG. 3. Preferably, the operation of the pair of opposing wave belts is synchronized to pair each wave ridge 30 of the upper discharge wave belt with each corresponding wave ridge of the lower discharge wave belt. Likewise, each wave trough 29 of the upper discharge wave belt is preferably synchronized with each corresponding wave trough of the lower discharge wave belt. When separated by the slot height 61 selected as a distance slightly larger than the diameter of the fruit 23, the pair of opposing wave belts creates a traveling pocket 65, that encloses each row of fruit 33 for smooth and gentle transport down the length of the delivery head, without adverse impact to the fruit, such as jarring, bumping or dropping.

Most preferably, as shown in FIG. 3, the upper discharge wave belt 60A is longer in length by one wave trough 29, as compared to the lower discharge wave belt 60B. This extra upper belt length 68 is located at the delivery infeed end 63 of the delivery head. This preferred embodiment serves to minimize the potential of adverse impacts to the fruit, in the transfer from the row feed discharge end 59 of the row feed conveyor 54 to the delivery infeed end of the delivery head. Specifically, the upper discharge wave belt collapses as it wraps around the first roller. Without the extra wave trough, the upper belt provides very little cushion to the incoming fruit 23, received from the row feed conveyor. The extra upper belt length provides additional, initial cushioning to the fruit falling the short distance from the row feed discharge end of the row feed conveyor.

Preferably, the row feed conveyor 54 hingably connects to the filler frame 43 at a row feed hinge 64, located proximate to the organizing mechanism 52. The row feed hinge allows the row feed conveyor, as coupled to the delivery head 42, to either raise or lower in response to the level of fruit 23 within the storage bin 22. Most preferably, this raising and lowering of the row feed conveyor and attached delivery head is accomplished by action of a row feed row feed actuator 66, as shown in FIG. 1. The row feed row feed actuator either raises or lowers the row feed conveyor, as needed, in response to the level of the fruit in the storage bin, as sensed by a bin fruit level indicator 71, preferably the fruit level indicator is a component of a “fruit detection system” 72, discussed further herein. The row feed actuator most preferably connects between the filler frame and the row feed conveyor, as shown in FIGS. 1 and 3, to raise and lower the row feed conveyor in response to the level of the fruit within the storage bin, minimizing the distance the fruit drops after discharge from the delivery head 42. In an alternative embodiment of the present invention, the row feed conveyor may be shortened to a minimal length, as needed to provide the transport of fruit from the row reel to the delivery head.

Preferably, the delivery infeed end 63 of the delivery head 42 hingably connects to the row feed discharge end 59 of the row feed conveyor 54 at a delivery hinge 69, which allows the delivery head to access the entire storage bin 22, front to back. Most preferably, this front-to-back, sweeping movement of the delivery head is accomplished by action of a delivery head actuator 67. The delivery head actuator 67 connects between the filler frame 43 and the delivery head 42, as shown in FIG. 3. The delivery head actuator serves to “wag” or sweep the delivery discharge end 61 of the delivery head across the storage bin in response to the level of the fruit 23 within the storage bin. This action evenly distributes the fruit into all portions of the storage bin.

To best articulate the delivery head 42, a delivery head actuator 67 preferably operates in concert with the row feed actuator 66, to fully articulate the bin filler 20. The loading the fruit into the storage bin in this manner maintains a relatively flat layer of fruit in the bin. Alternatively, the storage bin 22 could be moved laterally along the filler frame 43, preferably by action of a bin actuator. The bin actuator most preferably connects the filler frame to the storage bin, to move the storage bin vertically, similar in effect to the action of the row feed actuator. By employing the bin actuator, the action of the delivery head actuator could be limited to maintaining the delivery discharge end 62 of the delivery head at the level of the fruit 23 within the storage bin, sweeping back-and-forth, while the bin actuator maintains the fruit at a constant level, by raising and lowering the bin.

The row feed actuator 66, the delivery head actuator 67 and alternatively the bin actuator, are all preferably “ball-screw” actuators of conventional design, well known to those persons skilled in the field of industrial actuators. Ball screw actuators, operate by the rotation of a ball received within a screw, powered by an electric motor with an electric brake to halt movement of the actuator at any desired point. Alternatively, a standard stepping motor could be employed to also produce piston-like motion of the screw. Most preferably, to precisely measure and control the movement of the screw piston, the ball screw is attached to an “encoder.” The encoder is also a standard control component providing precise measurement of the ball screw rotation corresponds to linear position of the piston. A controller processes signals from the encoder to maintain or change motor rotation. To extend or retract the actuators, a ball nut attached to the piston rotates the ball screw, so the speed of actuation is directly proportional to the rotational speed of the stepping motor.

As an alternative to the preferred encoder, a linear transducer could be employed to sense piston position in relation to linear displacement of the transducer. In one widely used system, a transducer housing is mounted to a piston end, with a sensor rod extending to opposite end of the piston.

As an alternative to the preferred actuators, hydraulic actuators with conventional pistons and cylinders may be employed. Also, a hydraulic amplifier may be employed to control the position of the actuator by hydraulically amplify the motion of a stepping motor.

Also alternatively, the row feed actuator, the delivery head actuator and the bin actuator could be any conventional actuation means, including pneumatic cylinders, rack and pinion gears, or manual levers. The row feed actuator, the delivery head actuator and the bin actuator are preferably controlled by programable logical routines, with sensor input from the interface between the delivery head and the fruit level in the storage bin, which are included in the fruit detection system 72.

A most preferred fruit detection system 72 is provided between the accumulating alternating belt 46 and the organizing mechanism 52. As shown in FIG. 1, the organizer plate 47 of the fruit detection system can comprise a plurality of spring supported plates 74. When the piece of fruit 23, as a component of the fruit row 33 rests on the organizer plate, the organizer plate lowers and a proximity switch senses the movement. The fruit detection system serves to indicate when one of the multiple of reel troughs 56 of the row reel 55 organizing mechanism is full and ready to rotate, to transfer the fruit gathering on the organizing plate, into the row feed receiving end 58 of the row feed conveyor 54.

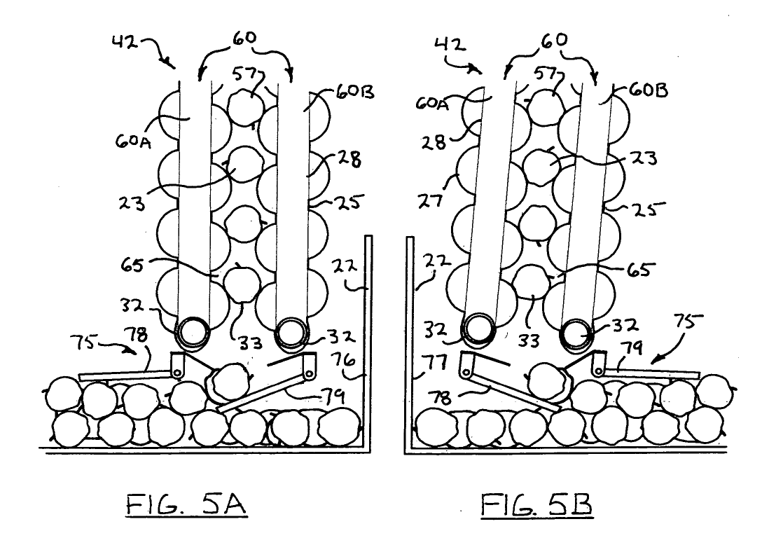

Simple robotics are preferably utilized to distribute the fruit evenly in the storage bin 22. FIGs. 5A and 5B show how a drape 75 can be utilized to facilitate the gentle dispersal of the fruit 23 into the storage bin. The drape is preferably formed of a resilliant material, such as a plastic, adequately cushioned to minimize damage to the fruit. Specifically, as the delivery discharge end of the delivery head move toward a front bin wall 76, the drape preferably trails the delivery head, helping to place the fruit into the lowest position possible within the storage bin. When the discharge end reaches the front bin wall, the discharge head preferably raises slightly, by actuation of the row feed actuator, and the drape “flips,” now directed toward a back bin wall 77. The delivery head is lowered to its original position and continues filling the storage bin, while traveling toward the back bin wall. The trailing drape also continues to help place the fruit into the lowest position available within the storage bin. Most preferably, the drape includes an upper drape 78, mounted proximate to the second roller 32 of the upper discharge wave belt 60A, and a lower drape 79, mounted proximate to the second roller of the lower discharge wave belt 60B.

In alternative embodiments of the present invention, a low pressure transducer, coupled with a water-filled tube, or an upwardly movable plate coupled with proximity sensors at each end can be employed to “feel” the fruit 23 and the storage bin 22 positions by detecting movement and thus the presence of an object below the plate, or the presence of fruit within the bin.

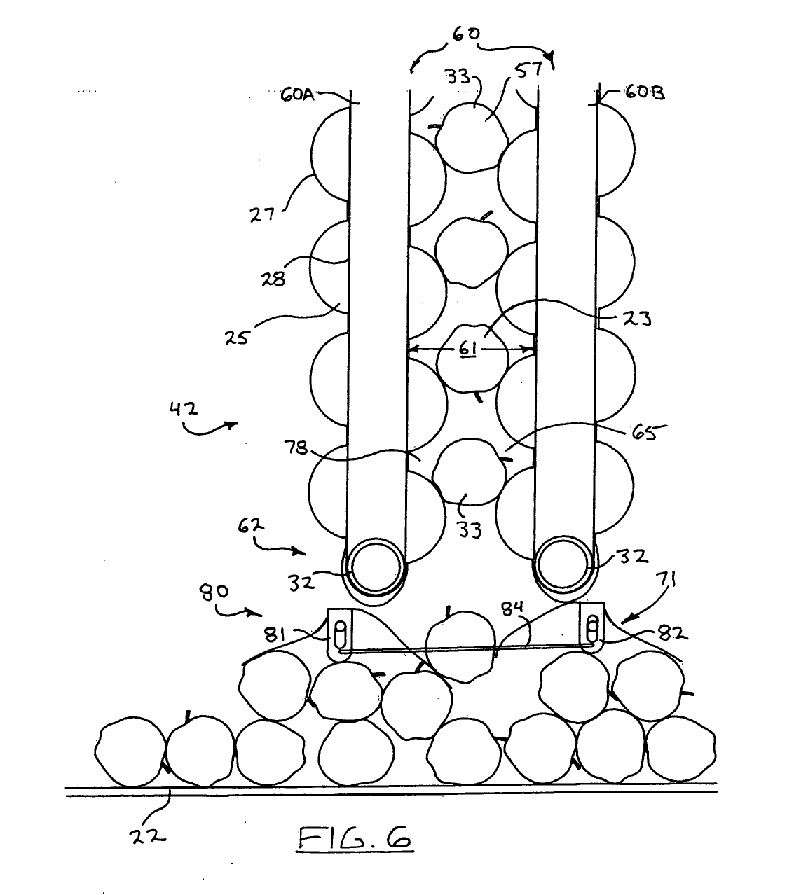

With the above described mechanisms, the bin filler 20 further comprises a unique, low energy fruit transfer method. The kinetic energy of the apples, or other fruit 23, is controlled throughout the transfer or movement of the fruit from the infeed 44 to the storage bin 22, by utilizing the wave shaped belts 25 to maintain minimum “drops” at each point of transfer. This wave belt arrangement provides advantages over known technology. The wave shaped belt absorbs any kinetic energy the fruit may have, providing a padded pocket 78, as the fruit is delivered by the wave shaped belt, minimizing bruising to the fruit. Specifically, the wave shaped belt transfers the fruit in the wave trough 29 of the wave shaped belt, delivering the fruit to the next position, while imparting to it a minimum of kinetic energy. The final release of the fruit into the storage bin is accomplished by what is essentially a pulling of padding from under the fruit, placing the fruit gently into the storage bin, which is an orderly approach, rather than loading the fruit randomly, as is the conventional method for such a transfer. As the overlying wave belt 27 of the wave shaped belt travels around the second roller 32, the wave ridge disappears as it flattens against the underlying conveyor belt 28, as shown in FIG. 6. This transfer methodology keeps the fruit or apples in an appreciably lower state of kinetic energy than current, known equipment. The results are the highest probability that the fruit will not be damaged at this critical point of the transfer process.

The method filling the storage bin 22 with fruit 23, employing the bin filler 20 of the present invention includes the steps of receiving the row of fruit 33 from the delivery head 42, by providing the padded pocket 78, out of which the fruit falls as it is dropped from the delivery head into the storage bin 22. A preferred step in the method for automatically filling the storage bin includes delivering the fruit to the organizer 41, the organizer comprising of an organizing mechanism 52, for organizing the fruit into the succession of fruit rows 57. The organizing of the fruit into succession of fruit rows can additionally include the step of processing the fruit with an accumulating alternating belt 46, for transferring the fruit to the organizing mechanism. The accumulating alternating belt preferably operates to direct the fruit away from the infeed 44.

After organizing the fruit 23 into the succession of fruit rows 57, the succession of fruit rows is then transferred to the delivery head 42, with the row feed conveyor 54. As discussed above, the delivery head includes the pair of opposing wave belts 60, and the pair of opposing wave belts, specifically, the upper discharge wave belt 60A and the lower discharge wave belt 60B. Each wave belt includes the underlying conveyor belt 28, which is a standard, substantially flat conveyor belt, with the overlying wave belt 27, which has the series of wave shapes or wave ridges 30, along the length of the overlying wave belt. The wave belts are preferably components of conventional wave shaped belt conveyors 25, with the underlying conveyor belt travelling continuously about both the first roller 31 and the second roller 32. The overlying wave belt collapses against the underlying belt, when traveling around the first roller and the second roller of each respective upper and lower discharge wave belts. The succession of fruit rows is contained between the pair of opposing wave belts, and the opposing wave belts together cradle each of the succession of fruit rows between the pair of opposing wave belts.

Within the delivery head, the fruit 23, in the form of the succession of fruit rows 57, are lowered the length of the delivery head 42, down to the storage bin 22. The fruit is then released from the delivery head and deposited into the storage bin. With the action of the delivery hinge 69 and the row feed hinge 64, a relatively flat layer of fruit is maintained in the bin. Articulating the row feed conveyor 54 at the row feed hinge, the attached delivery head is raised or lowered into the bin, responsive to the level of the fruit within the bin. The delivery head is also articulated to maintain the fruit within the bin in a flat layer, with the delivery head actuator 67. The delivery head actuator pivots the delivery head about the delivery hinge, to place the delivery discharge end 62 of the delivery head at any desired position in the bin.

As shown in FIG. 6, the level of fruit 23 in the storage bin 22 can be detected with a fruit level sensor 80. The fruit level sensor is preferably located proximate to the delivery discharge end 62 of the delivery head 42. Preferably, to prevent bruising of the fruit, the fruit row 33 at the discharge end is not released until the fruit level sensor is depressed. When the fruit level sensor is depressed, upon contact with fruit, the delivery head rotates one “step,” or distance to the next traveling pocket 65 or wave trough 29, to release the row of fruit. Then the delivery head simply raises by action of the row feed actuator 66, until the fruit level sensor is no longer depressed. The delivery head immediately moves on, in a row-wise progression across the storage bin, and lowers again to release the next fruit row, now in position at the discharge end.

Most preferably, the fruit level sensor includes an upper fruit level sensor 81, mounted proximate to the second roller 32 of the upper discharge wave belt 60A, and a lower fruit level sensor 82, mounted proximate to the second roller of the lower discharge wave belt 60B. In FIG. 6, the upper fruit level sensor is not depressed. However, the lower fruit level sensor is depressed, and will signal the row feed actuator to raise the entire delivery head, until the sensor is no longer depressed, after release of the fruit row 33, as discussed above. As also shown in FIG. 6, a connector rod 84 can be included to interconnect the upper fruit level sensor and lower fruit level sensor, to prevent independent “wagging” of the fruit level sensors. Most preferably, the connector is covered with a well-cushioned pad.

The operational method of the bin filler 20 may additionally include sensing the presence of the fruit 23 in the organizer 41, to control the speed of the fruit delivered to the storage bin 22 by the delivery head 42. As discussed above, the organizer preferably includes the organizer plate 47, which gathers the fruit for feeding into the row reel 55. The row reel rotates when the presence of a full row of fruit is detected on the organizer plate.

The operation of the entire bin filler 20 can be cued by the rotation of the row reel, as fruit 23 is detected by the organizer plate. A rotation of the row reel elicits a single, stepwise movement of the row feed conveyor 54, progressing one fruit row 33 toward the delivery head 42. As the row feed conveyor move, so the delivery head proceeds one fruit row step, and deposits a fruit row into the bin, as the delivery head also receives a fruit row at its delivery infeed end 63. The infeed 44 is also controlled by the organizer plate, as a lack of or alternatively an excess of fruit weight detected on the organizer palate will require a respective speeding up or slowing of the infeed conveyor 45.

In compliance with the statutes, the invention has been described in language more or less specific as to structural features and process steps. While this invention is susceptible to embodiments in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

1. A bin filler apparatus for automatically filling a storage bin with a fruit, the apparatus comprising:
an organizer, and a delivery head;
the organizer includes an infeed conveyor for delivering the fruit to an organizing mechanism, the organizing mechanism organizes the fruit into a succession of fruit rows for transfer to the delivery head; and
the delivery head including a pair of opposing wave belts, the pair of opposing wave belts spaced apart to receive and contain the succession of fruit rows between the pair of opposing wave belts, the opposing wave belts of the delivery head each including an wave shaped belt, the wave shaped belt travels continuously about a first roller and a second roller, and the wave shaped belt collapses against first roller and the second roller as the wave shaped belt travels around the first roller and the second roller, and the opposing wave belts together cradle each of the succession of fruit rows, to lower the fruit into the storage bin.

2. The bin filler apparatus of claim 1, wherein;
the organizer includes an accumulating alternating belt, the fruit accumulated on the accumulating alternating belt transfers to the organizing mechanism.

3. The bin filler apparatus of claim 2, wherein;
the accumulating alternating belt operates in a direction perpendicular to the direction of movement of the infeed conveyor.

4. The bin filler apparatus of claim 1, wherein;
the configuration of the succession of fruit rows is such that a full row of fruit, the entire width of the row contains fruit alternated with a partial row of fruit, with less than a full row of fruit are provided at each end of the row, and the center of the row contains no fruit;
as the alternating rows are transferred to the delivery head and deposited in the storage bin; and
the deposit of succession of fruit rows into the storage bin results in an even, regular arrangement of the fruit in the storage bin.

5. The bin filler apparatus of claim 1, wherein;
the organizer including an organizing mechanism and a row feed conveyor, the organizing mechanism having a rotating row reel with a multiple of reel troughs, and each real trough for receiving a fruit row of the succession of fruit rows.

6. The bin filler apparatus of claim 1, additionally wherein;
a fruit detection system is provided between the accumulating and alternating belt and the organizing mechanism, the fruit detection system comprising a plurality of spring supported plates, the plate lowers and a proximity switch senses the movement when a piece of fruit rests on the fruit detection plate; and the fruit detection system serves to indicate when the rotating organizing mechanism is full.

7. The bin filler apparatus of claim 1, wherein;
an upwardly movable plate with proximity sensors, sense the fruit in the organizer by detecting a movement and a presence of the fruit on the upwardly movable plate.

8. A bin filler method for automatically filling a storage bin with a fruit, the bin filler method including the steps of:
a) delivering a fruit to an organizer;
b) organizing the fruit into a succession of fruit rows with the organizer;
c) transferring the succession of fruit rows to a delivery head with the row feed conveyor, the delivery head having a pair of opposing wave belts, the pair of opposing wave belts each comprising an underlying conveyor belt with an overlying wave shaped belt, the underlying conveyor belt travelling continuously about a first roller and a second roller, the overlying wave shaped belt collapsing against the underlying belt when traveling around the first roller and the second roller;
d) containing the succession of fruit rows between the pair of opposing wave belts, and the opposing wave belts together cradling each of the succession of fruit rows between the pair of opposing wave belts;
e) lowering the fruit the length of the delivery head; and
f) depositing the fruit into the storage bin.

9. The bin filler method of claim 8, additionally including the step of:
g) sensing the presence of the fruit in the organizer to control the speed of the fruit delivered to the storage bin by the delivery head.

10. The bin filler method of claim 8, additionally including the step of:
g) maintaining a relatively flat layer of fruit in the bin.

11. The bin filler method of claim 8, additionally including the step of:
g) distributing the fruit along the length of an organizing mechanism with an accumulating alternating belt, the accumulating alternating belt operating in a direction perpendicular to the direction of movement of the infeed conveyor, to evenly distribute the fruit along the width of the organizer, for orderly introduction into the organizing mechanism.

12. The bin filler method of claim 8, additionally including the step of:
g) processing the fruit with an organizing mechanism to organize the fruit into a succession of fruit rows for transfer to the delivery head.
